(19) United States
(12) Patent Application Publication
(10) Pub. No.: US 2015/0256496 A1
(43) Pub. Date: Sep. 10, 2015

(54) Systems and Methods for Communicating Opinions About and/or To Individuals and/or Organizations

(71) Applicants: Gary W. Guttman, New York, NY (US); Tulasi D. Movva, Trumbull, CT (US)

(72) Inventors: Gary W. Guttman, New York, NY (US); Tulasi D. Movva, Trumbull, CT (US)

(21) Appl. No.: 14/560,641

(22) Filed: Dec. 4, 2014

Related U.S. Application Data
(63) Continuation-in-part of application No. 14/199,777, filed on Mar. 6, 2014, now abandoned.

(51) Int. Cl. H04L 12/58; G06Q 30/00; G07C 13/00

(52) U.S. Cl. CPC H04L 51/18; G07C 13/00; H04L 51/16; G06Q 30/016

(57) ABSTRACT

Systems and methods allow users to communicate opinions about one or more organizations directly to the one or more organizations. Specifically, a user may communicate praise and/or a grievance relating to an organization. The user may choose to share the communication with contacts in the public and/or private sectors, print media, social media and/or industry review organizations. Additionally, the user may include pictures, video or audio recordings to support their communications. Moreover, the communication may be directed to the specific organization about which the user is communicating prior to its submission to other groups so that grievances can be corrected prior to being made public.

The present invention claims priority as a continuation-in-part to U.S. patent application Ser. No. 14/199,777, titled “Systems and Methods for Communicating Opinions About and/or to Individuals and/or Organizations,” filed Mar. 6, 2014, which is incorporated by reference herein in its entirety.

### TECHNICAL FIELD

The present invention relates to systems and methods that facilitate users' communication of their opinions about one or more organizations directly to the one or more organizations and selected others. Specifically, a user may utilize contact information assembled by the invention to communicate praise and/or a grievance relating to an organization. The user may copy contacts in the public and/or private sectors, print media, social media and/or industry review organizations by the user's email, snail mail or text message. Moreover, the user may direct the communication to the organization about which the user is communicating prior to submission to other groups so that praise and/or grievances and/or suggestions can be corrected prior to being made public.

### BACKGROUND

It is, of course, generally known to provide avenues for individuals to provide feedback relating to issues concerning public and/or private matters. Indeed, individuals like to be praised for work that is well done, and further typically would wish to hear of constructive criticism to better their offerings.

For example, companies that employ people who deal directly with consumers spend a great deal of time and money ensuring that those employees conduct their public relations in a manner that satisfies the company's requirements, which can range from common courtesy and decency to specific requirements set by the company or by law. Communication with and from consumers is key to ensuring that praise and criticism/grievances are directed to the company and, ideally, to its corporate representatives. Of course, many companies also wish to know whether there are issues relating to their offerings, whether of goods, services or otherwise.

Moreover, communication can often allow individuals, such as users of services, purchasers of goods, or other like individuals, to feel as if their opinions matter. Thus, if an individual feels very strongly about an issue, communicating how he or she feels about the issue can make the individual feel as if their issue is being addressed or at least listened to. So-called “venting” about issues can aid an individual in overcoming the issues, especially if it is clear that the criticism catalyzes changes.

In the past, entities have set up avenues for individuals to communicate, such as through regular mail, telephone, email, the internet and other methods. However, it is often difficult for an individual to determine the proper person with whom to communicate when the individual wishes to impart praise and/or criticism.

In addition, while an individual may impart a particular communication, especially a negative criticism, to a representative of the company, there is no guarantee that the communication will be heard or routed to those individuals who can create change within the organization, wasting the individual's criticism. Moreover, those without accountability may simply ignore the criticism. Oftentimes, an individual may provide constructive criticism to an organization about a particular issue, and the organization may do nothing to address the criticism. This can lead to frustration and the feeling that an individual's voice is not important.

While communication among individuals and organizations has increased over time, especially today where almost everyone seems to have an instant mode of communication at his/her fingertips in the form of a cellular phone, it is still very difficult to determine the best person in an organization to communicate an opinion to ensure that the opinion reaches the right people and is taken seriously.

A need, therefore, exists for systems and methods for facilitating communication of opinions about and/or to individuals and/or organizations. More specifically, a need exists for systems and methods for helping users impart praise and/or criticism about an entity through their email, snail mail or text messaging services.

Further, a need exists for systems and methods allowing users to instantly contact the proper individuals in an organization to air opinions. Still further, a need exists for systems and methods to allow organizations instant access to opinions that may be important to the organization.

In addition, a need exists for systems and methods allowing users to easily copy media, social media and networking websites on the user's communication. Moreover, a need exists for systems and methods allowing users to direct their communication to appropriate communication networks and through the web/internet.

### SUMMARY OF THE INVENTION

The present invention relates to systems and methods that facilitate users' communication of their opinions about one or more organizations and/or individuals in those organizations directly to the one or more organizations and to selected others. Specifically, a user may communicate praise and/or a grievance relating to an organization by means of their email, snail mail or text message utilizing the contact information assembled by the invention. The user may copy contacts in the public and/or private sectors, print media, social media and/or industry review organizations. Moreover, the user may direct communication to the organization about which the user is communicating prior to submission to other groups so that grievances can be corrected prior to being made public.

To this end, in an embodiment of the present invention, a system is provided for aiding and facilitating communication of opinions about and/or to individuals and/or organizations. The system comprises user clients interconnected to the internet, and database and engine modules for storing hierarchical information relating to entities and contact information for the entities, the database and engine modules which receive all communications from a users' client relating to an entity, and the entities selected by the user based on choices made by the user.

Moreover, in another embodiment of the present invention, a method is provided, the method comprising creation of a message relating to an opinion about an entity on a user client implemented on a computing device, interconnection of the computing device to the internet, the user client communicating with a database to select a recipient for the message, sending the message to the recipient, and optionally sending the message to a social media site for publishing of the message.

It is, therefore, an advantage and objective of the present invention to provide systems and methods for communication of opinions about and/or to individuals and/or organizations. Preferably, the individuals relate to public officials, such as politicians and the like, being accountable to others.

More specifically, it is an advantage and objective of the present invention to provide systems and methods for allowing users to impart praise and/or criticism about an entity.

Further, it is an advantage and objective of the present invention to provide systems and methods allowing users to instantly contact the proper individuals in an organization to air opinions.

Still further, it is an advantage and objective of the present invention to provide systems and methods to allow organizations instant access to current feedback on their goods and/or services.

In addition, it is an advantage and objective of the present invention to provide systems and methods allowing users to share opinions with media, social media and networking websites.

Moreover, it is an advantage and objective of the present invention to provide systems and methods allowing users to communicate with existing communication networks and through the web.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts by way of example only, not by way of limitations. In the figures, like reference numerals refer to the same or similar elements.

FIG. 1 illustrates a system overview in an embodiment of the present invention.

FIG. 2 illustrates an exemplary screenshot showing a user interface in an embodiment of the present invention.

FIG. 3 illustrates an exemplary screenshot showing a user interface in an embodiment of the present invention.

FIG. 4 illustrates an exemplary screenshot showing a user interface in an embodiment of the present invention.

FIG. 5 illustrates an exemplary screenshot showing a user interface in an embodiment of the present invention.

FIG. 6 illustrates an exemplary screenshot showing a user interface in an embodiment of the present invention.

FIG. 7 illustrates an exemplary screenshot showing a user interface in an embodiment of the present invention.

FIG. 8 illustrates an exemplary screenshot showing a user interface in an embodiment of the present invention.

FIG. 9 illustrates an exemplary screenshot showing a user interface in an embodiment of the present invention.

FIG. 10 illustrates an exemplary screenshot showing a user interface in an embodiment of the present invention.

FIG. 11 illustrates an exemplary screenshot showing a user interface in an embodiment of the present invention.

FIG. 12 illustrates an exemplary screenshot showing a user interface in an embodiment of the present invention.

FIG. 13 illustrates an exemplary screenshot showing a user interface in an embodiment of the present invention.

FIG. 14 illustrates an exemplary screenshot showing a user interface in an embodiment of the present invention.

FIG. 15 illustrates an exemplary screenshot showing a user interface in an embodiment of the present invention.

FIG. 16 illustrates an exemplary screenshot showing a user interface in an embodiment of the present invention.

FIG. 17 illustrates an exemplary screenshot showing a user interface in an embodiment of the present invention.

FIG. 18 illustrates an exemplary screenshot showing a user interface in an embodiment of the present invention.

### DETAILED DESCRIPTION OF THE PRESENTLY PREFERRED EMBODIMENTS

The present invention relates to systems and methods for allowing users to communicate opinions about one or more organizations and/or individuals in those organizations directly to the one or more organizations. Specifically, a user may communicate praise and/or a grievance relating to an organization through the user's communication means, such as via email, text, snail mail or other like communication means. The communication may be presented to contacts in the public and/or private sectors, print media, social media and/or industry review organizations. Moreover, the communication may be specifically directed to the organization about which the user is communicating prior to its submission to other groups so that grievances can be corrected prior to being made public.

In an overview of the present invention, an extensive database of contacts in the public and private sectors, print media, social media and/or industry review organizations, and/or other like organizations is maintained. A user may communicate immediately with an organization, business or political representative of the user's choice to express his or her opinion, grievance or praise. The opinion may be expressed through standard communication mechanisms, such as email, snail mail, instant message, voice communication, or other like communication methods. The user may create an electronic message, and may further attach multimedia files, such as voice files, video files, photographs, and other multimedia to the communication to augment or support the user's opinion. Additionally, the user may choose to share opinions with the user's personal network, such as his or her address book, or various social networks, such as, for example, Facebook, Twitter, print media, industry reviewers, or other like entities.

Generally, a user utilizes mobile or desktop clients through web-based applications. For example, the ability to use a smartphone and register opinions immediately is a key feature of the present invention.

The present invention may also utilize GPS technology to ascertain the user's location and, based on the user's location, may offer suggestions to the user with respect to the business with which the user wishes to communicate. For example, if the user has an opinion about Starbucks and is then within a Starbucks, the present invention may offer the user the opportunity to direct his or her opinion to that Starbucks' location and/or to Starbucks' corporate.

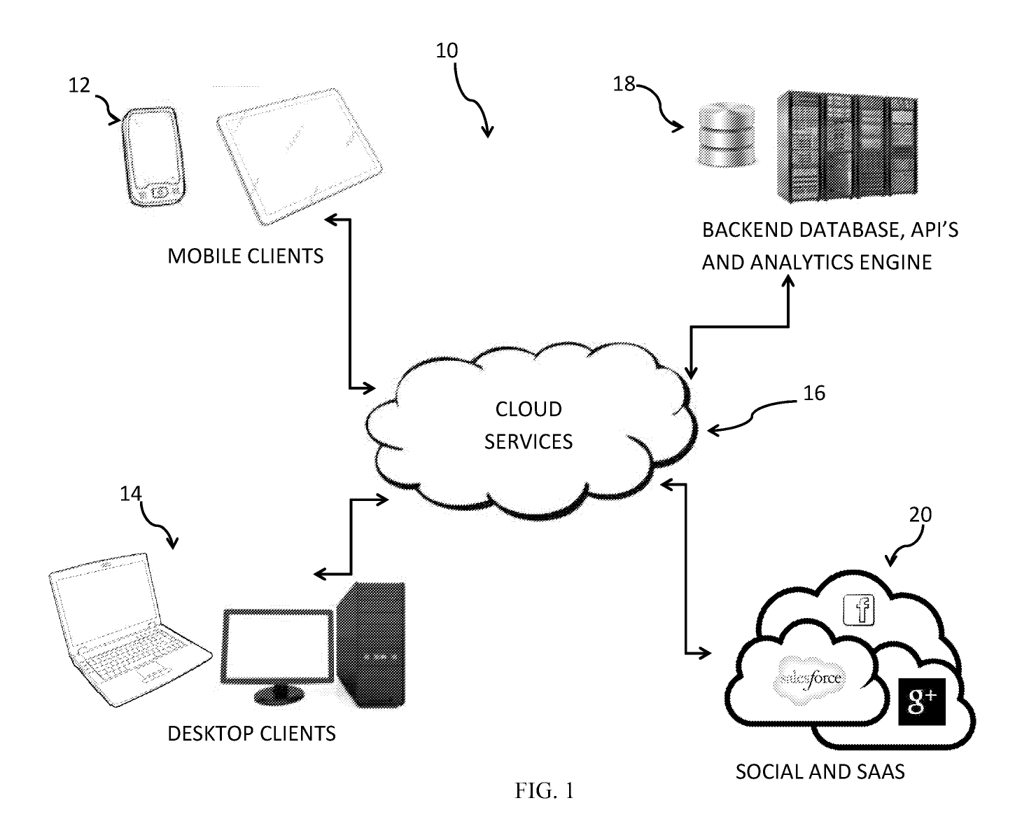

Now referring to the figures, wherein like numerals refer to like parts, FIG. 1 illustrates an overview of an exemplary system [10] of the present invention, comprising mobile clients [12] and desktop clients [14] that may communicate through internet-based networking [16], such as cloud services and the like, to a backend database and engine [18]. Thus, a user of the system [10] of the present invention may utilize either the mobile clients [12] or the desktop clients [14] to air an opinion through the internet [16] directly to an organization and/or to various social network sites, to reviewers, regulators or the like. The backend database and engine [18] may drive identification and provide contact information and names of those to receive the message.

The present invention may utilize a hierarchical structure of domains and sub-domains in the backend database and engine [18] to offer a user with the proper names to whom to direct his or her opinion about a particular matter. Specifically, the present invention may utilize the hierarchical domain and sub-domain architecture to present options to the user to drill down to find the proper individual or entity to which to direct the opinion. Once the proper entity has been identified, the present invention may automatically provide the contact information to the user so that the message may be directed to the proper individual within that entity.

For example, if a user has an opinion relating to a particular hotel, the user may select a domain of “Travel” in a level 1 hierarchy followed by “Hotel” in a level 2 hierarchy, followed by the name of the hotel in a level 3 hierarchy. Once the name of the hotel has been selected or directly entered by the user, the present invention may automatically fill in the proper contact information, such as email address or the like, and the user may deliver the opinion directly to the proper individual at that specific hotel.

Each domain and sub-domain may have its own potentially unique set of regulators, reviewers and problem types or grievance categories that the user may designate. For example, the “Public” domain may have three sub-domains, such as “Federal”, “State” and “Local”, each of which may have further breakdowns. Appendix A details an exemplary list of hierarchical levels, including specific domains and sub-domains that may be utilized in the present invention. However, it should be noted that the domains and sub-domains provided in Appendix A are merely exemplary, and the invention should not be limited as designated therein, as the domains and sub-domains can be defined in any manner apparent to one of ordinary skill in the art.

Moreover, the present invention may aid a user in determining the proper domain and sub-domain(s) for directing the opinion based on the user's location. Specifically, if an opinion generated by a user is attributable to an occurrence or happening at a particular location such as, for example, within a retail store or otherwise in close proximity to the organization to which the opinion is relates the user may opt to allow the present invention to determine the user's present location using GPS or other location identifying means. The present invention may then be able to identify the proper entity to direct an opinion based on the user's present location.

For example, if the user has an opinion about a retail store, the present invention, embodied as an app on the user's smart phone, may utilize specific location identifying means to determine the present location of the user, and may provide an option for the user to direct his/her opinion to the managers at the location, such as the retail store, or to the corporate headquarters of the business.

The primary function of the present invention is to enable a user to express an opinion on an issue or a problem with a product, service, company, political body, or any other issue, to the individuals who can make a difference, such as the owner, manager or CEO of a business, the local congressman or senator and/or local officials. The present invention allows a user to select the party or parties to be contacted from a database and to communicate directly and/or immediately with them the specifics of the user's concern and, if the user wishes, to have the communication include photos, voice and/or video. The present invention also may allow a user to disseminate his/her comments to all or part of the user's address book, to reviewers of the entity to which the opinion is related, to social media and, in case the user's opinions relate to a regulatory matter, to regulators.

In an alternate embodiment of the present invention, social networks may be built between or among users of the present invention based on the subject matter of the opinion or some other commonality between users of the present invention. For example, social communities may be built based on common domain interests, such as political candidates or common grievances with specific businesses. Alternatively, social communities may be built on other matters less to do with the substance of the opinion, such as the style of the opinion. For example, there may be contests held for “most original” opinion or the like.

The database and engine [18] may be implemented in any manner apparent to one of ordinary skill in the art, such as modular or the like. A database may be utilized to hold the information concerning the particular domains and sub-domains in the hierarchical structure and the particular contact information relating to entities. The database may be partitioned between the user's mobile or desktop clients and the cloud, allowing specifics about the user's opinion and the recipients of the communication to be maintained both on the user's client, such as mobile client, and in the cloud. The cloud, therefore, may serve as both a back-up of the user's client's database partition and a central repository for the storage of opinions.

The data in the cloud may be aggregated (for example, by user type, by type of problem, by target, or other substantive specification). Limited access to the aggregated information (not identifiable to any particular person) may be sold to business or political groups that may be interested in obtaining opinions about the particular business or political group. This may allow the business or political group to gauge how it is doing with the public and/or may provide information about its performance. Moreover, the database may support targeted advertising to users from organizations that offer specific solutions to customers' issues. The database may also permit copies of opinions intended to go to regulators, print media, and/or social media to be “held” for a specified short period of time to allow the business that is the subject of the communication to address and/or resolve the user's grievance before copies of the opinion may be forwarded to the regulators or the media.

The database of domains, sub-domains, including specific contact information relating to entities, may be constantly updated by data entry professionals and/or business analysts that may constantly monitor the architecture to keep the database up-to-date. Updating may be automatic. The present invention also provides avenues for users to enter specific domain and sub-domain information into the database for an entity if the entity currently is not in a database as well as for new problem types and additional business domains.

The architecture of the present invention is preferably designed to be flexible and to allow for future expansion of functionality. Specifically, the database may be maintained in the cloud; a subset database may be maintained on the user's client, such as a smartphone, to the extent that space permits it to be. The present invention may maintain the domains most commonly referenced by users on the users' clients. Users may choose to keep all of their communicated opinions, some of them, or none of them via a setting on the user's client.

As described above, the present invention may further support the creation of common interest communities to users. Users may manage these special communities themselves, and oversight of these communities may be performed by proprietors of the present invention to preclude communications within these communities that may violate the law or common courtesies, or for similar reasons. Thus, domain-specific communities or special interest groups, such as frequent air travelers who wish to discuss air travel-related issues and/or lobby one or more carriers to make changes sought by their special interest group, may be accomplished.

Thus, if there are many users having commonalities in the types of opinions aired, the subject matter, the target thereof, or any other commonality, the present invention may facilitate the creation of communities by allowing direct communication among members thereof, such as a message board or the like. Therefore, users may obtain specific information relating to their opinions or other opinions in which they may have an interest.

### EXAMPLE

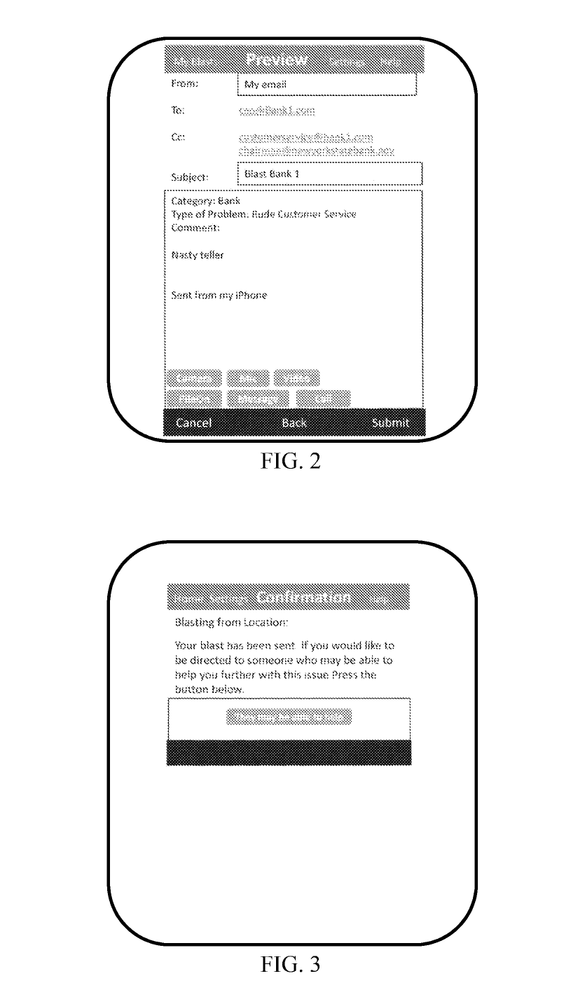

In an exemplary embodiment of the present invention, FIGS. 2-15 illustrate screenshots illustrating a user interface for a user to utilize the systems and methods of the present invention. FIG. 2 illustrates a user interface implemented on a user client, such as a user's computing device, whether smartphone, desktop, or other user client, allowing a user to input an opinion and direct it to an organization of choice. Specifically, the organization may be determined using the domain/sub-domain hierarchy, as described herein, or via the user's location identification system of his or her smart phone. As illustrated in FIG. 2, the organization to which the opinion is to be sent is addressed in the “To” field. At the bottom of the screenshot, the user may select mechanisms for inputting further data, such as inputting a photograph, recording audible data through a microphone, adding video, adding “Share” (allowing the user to add additional recipients), sending an SMS message or calling the same directly. Once the opinion is completed, the user may submit the opinion by using the “Submit” button. FIG. 3 illustrates a confirmation screen showing that the users' opinion has been sent to the recipients selected. FIG. 3 further provides a button that may allow for direct contact with an individual who may be able to help or otherwise address the opinion regarding a problem. For example, selecting this option may allow the user to have a direct communication with a customer service representative, or another individual, who may be able to address the users' issue directly.

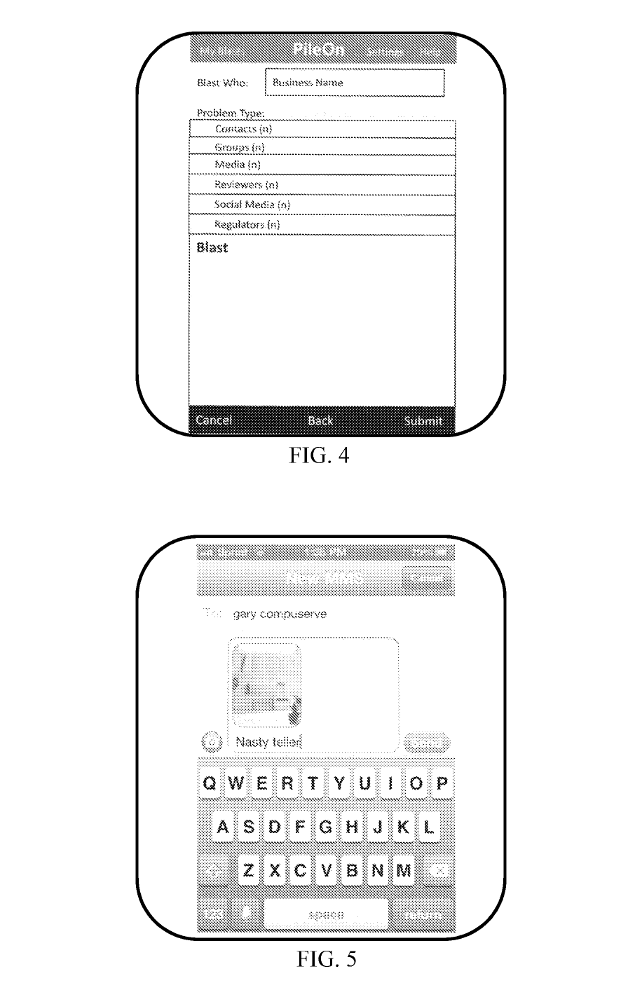

FIG. 4 illustrates a so-called “Share” screenshot allowing a user to input various others to which the user may wish to send the opinion. Specifically, the user may select particular contacts from his or address book, groups, print media, reviewers, social media, and/or regulators. The opinion may also be provided, and the user may then submit the opinion to these other parties once complete.

If the user selects “message” from the user interface, shown in FIG. 2, the user may create an SMS message, as illustrated in FIG. 5. Multimedia may further be provided, such as a photograph or the like, which may be submitted via the SMS message.

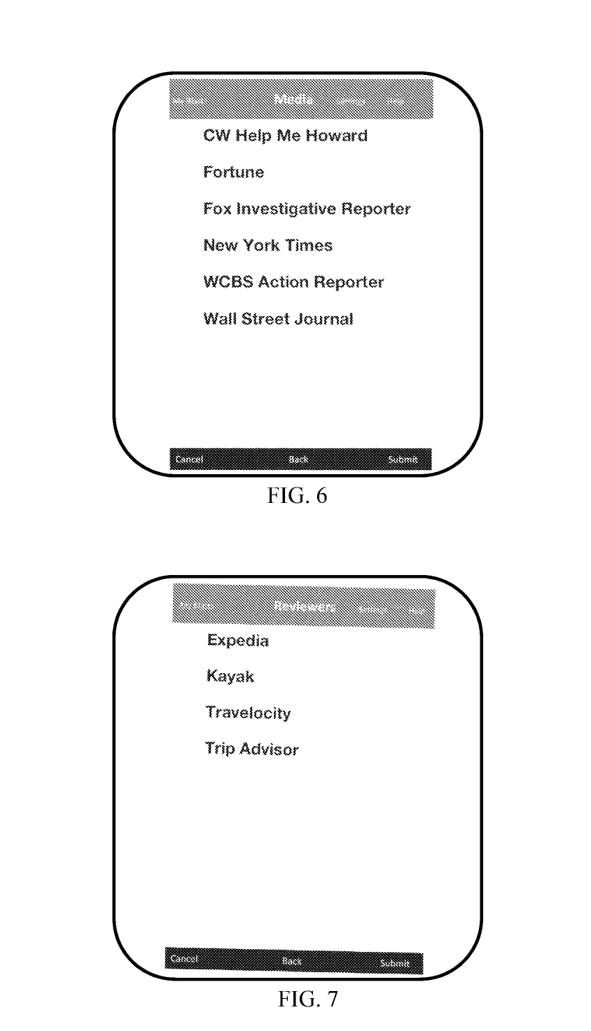

FIG. 6 illustrates examples of media that may be contacted if the user wishes to contact additional parties or entities regarding his or her opinion. Thus, the user may select one or more additional media outlets for receipt of the opinion.

If the user wishes to communicate with “Reviewers”, the user may select the “Reviewers” link, and depending on the subject matter of the opinion, the target domain or sub-domain of the opinion, or some other criterion, may provide a list of reviewers to which the user may wish to send the opinion. In many cases, reviewers may compile information concerning products and/or services of certain types of businesses. In the example shown in FIG. 7, the reviewers may relate to the travel industry.

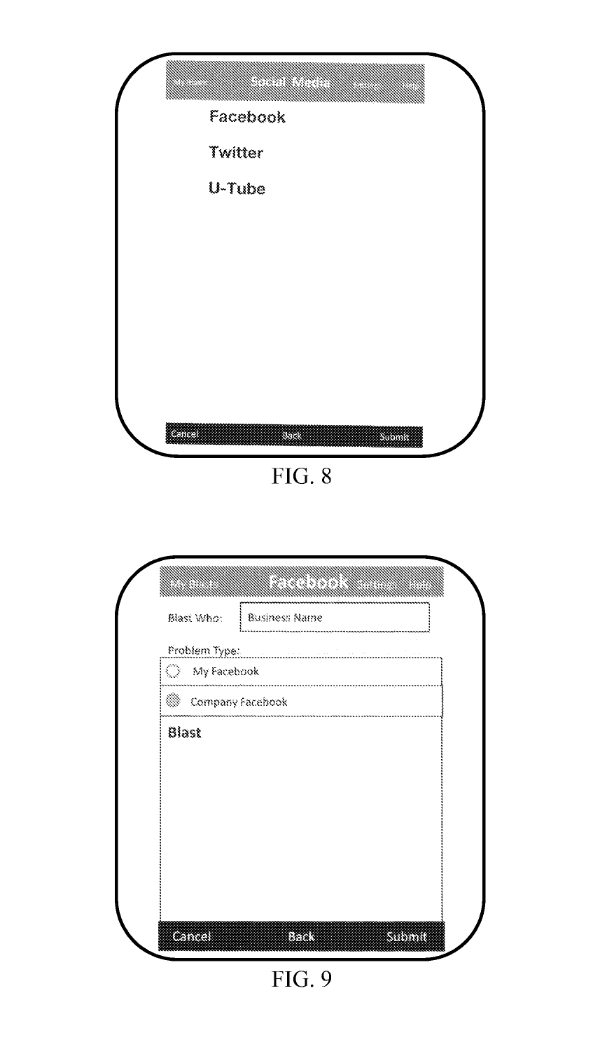

FIG. 8 illustrates specific social media that may be selected if the user wishes to send his or her opinion to a social media outlet, such as Facebook, Twitter, YouTube, or other like social media outlet. For example, as illustrated in FIG. 9, if Facebook is selected, the opinion of the user may be submitted to the user's Facebook page, another individual's Facebook page, and/or the Facebook page of the target of the opinion, such as a company's Facebook page.

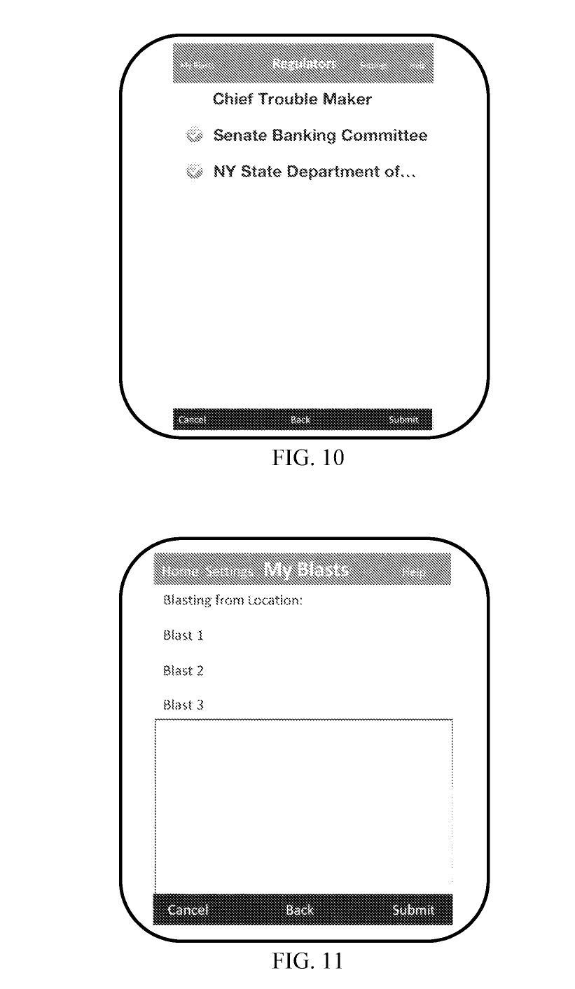

FIG. 10 illustrates specific regulators that may be selected if the user wishes to send the opinion to regulators. The list of regulators may be generated by the systems and methods of the present invention based on the type of problem, the target domain or sub-domain of the opinion, or via some other manner. The user may select one or more regulators to receive the opinion.

FIG. 11 illustrates a list of opinions that may have been generated by the user, which may be stored on the user's client. Thus, the user may retain a historical list of opinions submitted. The user may specify how many opinions to retain or whether to retain any previously submitted opinions.

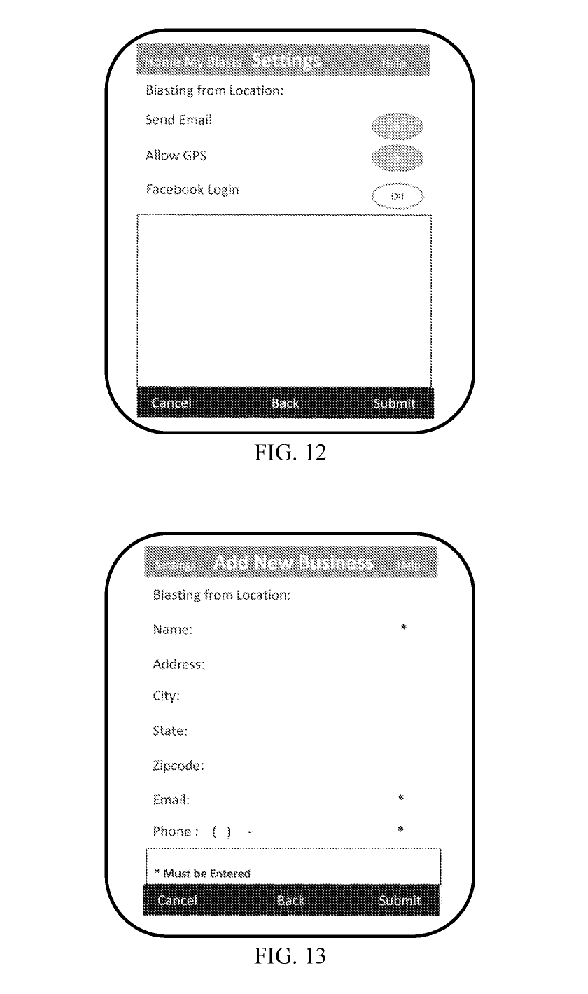

FIG. 12 illustrates an exemplary “settings” interface allowing a user to select whether to turn on or off certain features, such as sending of an email, allowing GPS to identify the user's present location, whether to log on to the user's Facebook page for submitting opinions and other like settings.

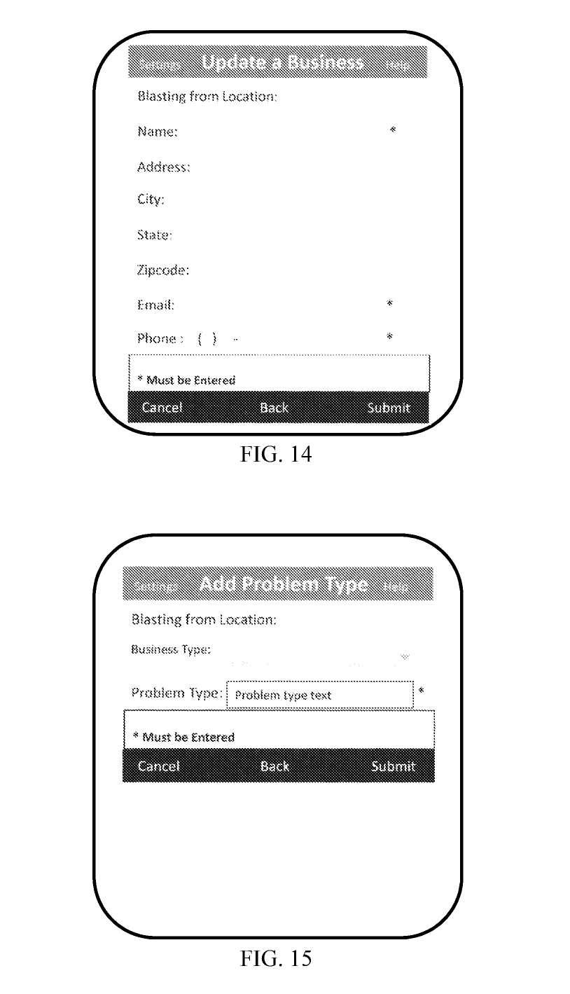

FIG. 13 illustrates a screenshot showing how a user may input information relating to an entity that may not be contained within the database for selection. The user may input as much information as he or she knows, and the entity information may be utilized by other users that may wish to send opinions to the inputted entity(ies). Thus, the database of entities to which a user may wish to send an opinion may be updated by users on an ongoing basis. The addition of entities may be monitored by administrators of the present invention. FIG. 14 shows a screenshot of a user interface for updating information about a business by a user if the user determines specific information about the business is not contained within the database.

Opinions may be classified in the database based on the problem type as illustrated in FIG. 15. Therefore, users may supply additional problem types if the particular problem they wish to send an opinion about is not represented in the problem types provided and stored by the database. Thus, the problem types may be updated on an ongoing basis. Of course, the addition of problem types may be monitored by administrators of the present invention as well as be created by the invention by scanning the complaint for specific key words and phrases.

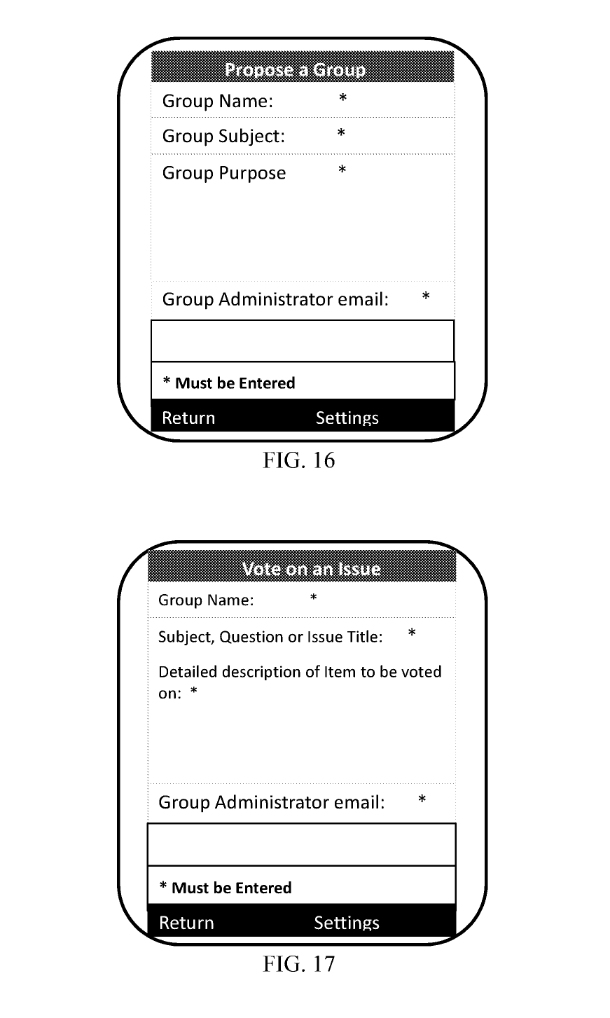

As shown in FIG. 16, the present invention may group, organize, or otherwise consolidate opinions related to each other. A user of the present invention may propose a group to administer such opinions. Likewise, a user may be able to add organizations, which may or may not be businesses, regulators, reviewers, media, or the like in order to further populate the database as described herein. For example, organizations such as the NRA may receive opinions from users under the present invention. The present invention may consolidate opinions previously voiced to non-grouped businesses, regulators, reviewers, media, associations, groups, or the like into newly proposed groups.

Within each group, issues raised in opinions may be consolidated as well. Many similar complaints may be consolidated such that each opinions sharing a particular issue may be linked together. This linking may draw attention to particular issues based on the number of opinions linked. The number of opinions linked, grouped, or consolidated may be output in a graphical representation to users or to businesses, regulators, reviewers, groups, or the like. The grouping or linking may also allow a particular user to further develop intricacies related to the issue that the particular user may have overlooked.

As shown in FIG. 17, the present invention may allow users to vote on a particular issue. In one embodiment, a large number of opinions may have been linked together creating a high demand for the resolution of the issue stated within the opinions. Users may then propose a vote on a resolution. Alternatively, administrative groups may propose a vote on a resolution. Alternatively, users or administrators may set up a vote unrelated to the resolution of the opinion, but related to which opinion is the best amongst all grouped or linked opinions. This ranking voting may propel users to formulate better, more logical, and more succinct opinions in the future in order to be ranked higher. Voting, as described herein, may be live and update as votes are entered. Alternatively, voting may be open for a limited period of time, such as a week, and the votes may update at particular intervals, such as daily.

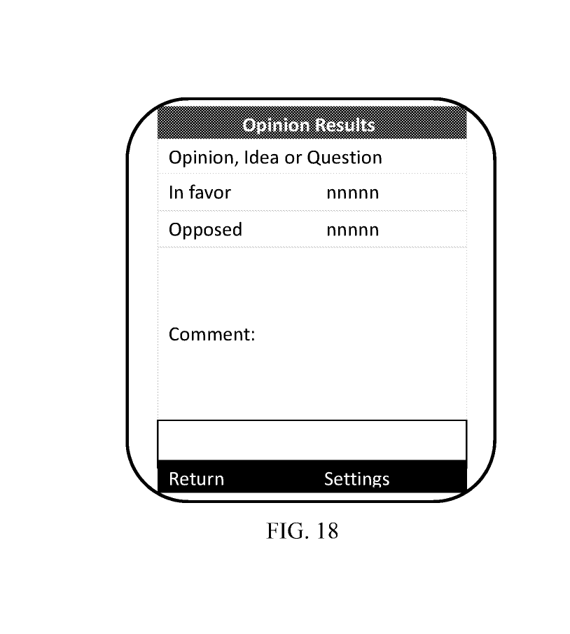

FIG. 18 illustrates the results of a vote on an opinion, idea, question, resolution, or the like. The present invention may display the number of votes for, against, or abstentions and may display any comments related to the voting process or result. Alternatively, the present invention may display votes of particular users and/or the user's history of voting. Data on a particular user may be displayed as an indication of how the particular user may vote in the future on similar issues.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method for aiding and facilitating communication of opinions comprising the steps of:
providing a computing device having a user interface for inputting information into the computing device, said computing device interconnected with a web portal for aiding and facilitating communication of opinions;
interfacing with the web portal with the computing device, said web portal interconnected with a hierarchical database comprising a plurality of contacts for a plurality of people and organizations;
providing access to the hierarchical database through the computing device;
receiving a plurality of opinions relating to at least one issue;
consolidating the plurality of opinions relating to the at least one issue with a plurality of previously received information relating to the issue.

2. The method of claim 1 further comprising the step of:
providing a vote on a resolution to the at least one issue.

3. The method of claim 2 further comprising the step of:
providing a plurality of results based on the vote on the resolution to the at least one issue.

4. The method of claim 3 wherein one of the plurality of results based on the vote on the resolution to the at least one issue includes a voting history of a particular user.

5. The method of claim 1 further comprising the step of:
providing a vote to determine a best opinion relating to the at least one issue.

6. The method of claim 5 further comprising the step of:
providing a plurality of results based on the vote determining the best opinion relating to the at least one issue.

7. The method of claim 1 further comprising the step of:
providing an option to add a business to the hierarchical database.

8. The method of claim 1 further comprising the step of:
providing an option to add a group to the hierarchical database.

9. The method of claim 8 further comprising the step of:
providing an option to add a group administer to the hierarchical database.

10. The method of claim 1 further comprising the step of:
storing the plurality of opinions relating to at least one issue in a storage database.

11. The method of claim 10 further comprising the steps of:
receiving a command for a history of the plurality of opinions relating to at least one issue in the storage database; and
sending the history of the plurality of opinions relating to at least one issue from the storage database to the computing device.

12. A system for aiding and facilitating communication of opinions comprising:
a computing device having a user interface for inputting information into the computing device, said computing device interconnected with a web portal for aiding and facilitating communication of opinions;
a web portal interfaced with the with the computing device, said web portal interconnected with a hierarchical database comprising a plurality of contacts for a plurality of people and organizations;
a first fillable recipient input field displayable on the computing device, wherein the first fillable recipient input field is filled with one of the plurality of contacts for a plurality of people and organizations in the hierarchical database;
a fillable opinion input field displayable on the computing device beneath the first fillable recipient input field;
a submission button interconnected with the computing device, wherein the submission button transmits an opinion filled in the fillable opinion input field to at least one of the plurality of contacts listed in the first fillable recipient input field through the web portal; and
a processing unit wirelessly connected to the computing device through the web portal, wherein the processing unit consolidates the transmitted opinion with a plurality of similarly related previously transmitted opinions.

13. The system of claim 12 wherein the processing unit transmits a voting prompt to at least one computing device that allows a user to vote on a resolution to at least one issue raised in the plurality of similarly related previously transmitted opinions.

14. The system of claim 13 wherein the processing unit collects a plurality of user votes from the at least one computing device and transmits a plurality of results based on the vote on the resolution to the at least one issue raised in the plurality of similarly related previously transmitted opinions.

15. The system of claim 14 wherein one of the plurality of results based on the vote on the resolution to the at least one issue raised in the plurality of similarly related previously transmitted opinions is a voting history of a particular user.

16. The system of claim 12 wherein the processing unit transmits a voting prompt to at least one computing device that allows a user to vote to determine a best opinion out of the plurality of similarly related previously transmitted opinions.

17. The system of claim 16 wherein the processing unit collects a plurality of user votes from the at least one computing device and provides a plurality of results based on the vote determining the best opinion out of the plurality of similarly related previously transmitted opinions

18. The system of claim 12 further comprising:
a tangible storage medium that stores a plurality of transmitted opinions.

19. The system of claim 18 wherein the processing unit relays a history of the plurality of transmitted opinions relating to at least one issue in the storage database to the computing device

20. The system of claim 12 further comprising an additional group implementation that allows a user of the computing device to propose a group.
